(19) United States
(12) Patent Application Publication
(10) Pub. No.: US 2023/0294305 A1
(43) Pub. Date: Sep. 21, 2023

(54) VACUUM PRESSURE FEEDING SYSTEM

(71) Applicant: FANUC CORPORATION, Minamitsuru-gun (JP)

(72) Inventors: Makito NAKAMURA, Minamitsuru-gun, Yamanashi-ken (JP); Masahiro MUROTA, Minamitsuru-gun, Yamanashi-ken (JP)

(21) Appl. No.: 18/018,320

(22) PCT Filed: Jul. 27, 2021
(86) PCT No.: PCT/JP2021/027625

§ 371 Date: Jan. 27, 2023

(30) Foreign Application Priority Data
Jul. 30, 2020 (JP) 2020-129037

(51) Int. Cl. B25J 15/06; B25J 19/02

(52) U.S. Cl. CPC B25J 15/0616; B25J 19/02

(57) ABSTRACT

A vacuum pressure feeding system is provided with a first vacuum pressure feeding path for feeding vacuum pressure from a vacuum source to a holder for holding an object using the vacuum pressure, a tank for storing vacuum pressure, a second vacuum pressure feeding path branching from partway along the first vacuum pressure feeding path and connecting to the tank, and a first electromagnetic valve provided on the second vacuum pressure feeding path.

### TECHNICAL FIELD

The present invention relates to a vacuum pressure supply system (vacuum pressure feeding system).

### BACKGROUND ART

JP 2014-050940 A discloses a robot hand that holds a workpiece by suctioning the workpiece. The robot hand includes a suction hole and a vacuum path communicating with the suction hole. The workpiece is held by being suctioned by means of vacuum pressure supplied to the suction hole via the vacuum path,

### SUMMARY OF THE INVENTION

However, in the robot hand disclosed in JP 2014-050940 A, when the supply of the vacuum pressure from the vacuum pump is disrupted, the workpiece falls off the robot hand. As a result, there is a possibility that the workpiece may be damaged.

It is an object of the present invention to provide a vacuum pressure supply system capable of stably holding an object using vacuum pressure.

According to an aspect of the present invention, there is provided a vacuum pressure supply system including: a first vacuum pressure supply path configured to allow a vacuum pressure to be supplied from a vacuum source to a holding unit configured to hold an object using the vacuum pressure; a tank configured to store the vacuum pressure; a second vacuum pressure supply path branching off from the first vacuum pressure supply path and being connected to the tank; and a first solenoid valve provided on the second vacuum pressure supply path.

According to the present invention, it is possible to provide a vacuum pressure supply system capable of stably holding an object using vacuum pressure.

### BRIEF DESCRIPTION OF DRAWINGS

FIG. 1 is a diagram illustrating a vacuum pressure supply system according to a first embodiment;

FIG. 2 is a diagram illustrating an example of an operation procedure of the vacuum pressure supply system according to the first embodiment;

FIG. 3 is a diagram illustrating a vacuum pressure supply system according to a second embodiment; and

FIG. 4 is a diagram illustrating an example of an operation procedure of the vacuum pressure supply system according to the second embodiment.

### DETAILED DESCRIPTION OF THE INVENTION

A vacuum pressure supply system according to the present invention will be described in detail below by way of preferred embodiments and with reference to the accompanying drawings.

### First Embodiment

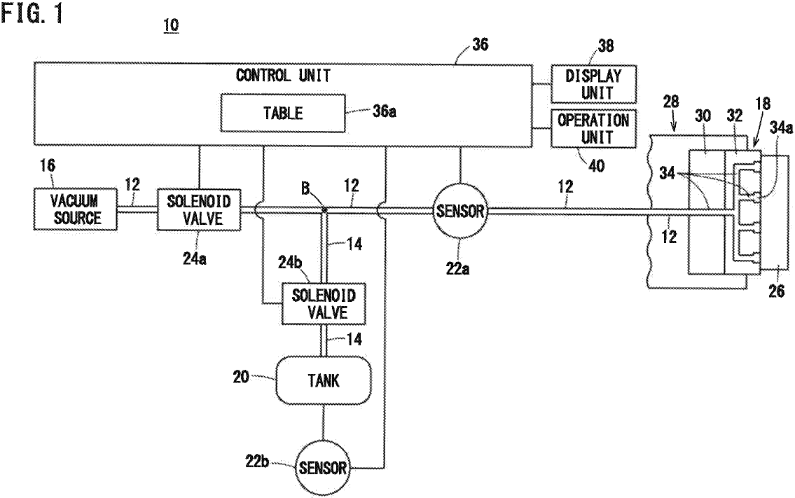

A vacuum pressure supply system according to a first embodiment will be described. FIG. 1 is a diagram showing a vacuum pressure supply system according to the present embodiment. As shown in FIG. 1, the vacuum pressure supply system 10 according to the present embodiment includes a vacuum pressure supply path 12, a vacuum pressure supply path 14, a vacuum source 16, a holding unit 18, a tank 20, a sensor 22a, a sensor 22b, a solenoid valve 24a, a solenoid valve 24b, a control unit 36, a display unit 38, and an operation unit 40.

The vacuum pressure supply path 12 supplies a vacuum pressure generated by the vacuum source 16 to the holding unit 18. The vacuum pressure supply path 14 branches off from the vacuum pressure supply path 12 and is connected to the tank 20. A position where the vacuum pressure supply path 14 branches off from the vacuum pressure supply path 12 is referred to as a branch point B. The vacuum pressure supply path 14 allows the tank 20 to be supplied with the vacuum pressure generated by the vacuum source 16 and flowing into the vacuum pressure supply path 14 from the branch point B of the vacuum pressure supply path 12. The vacuum pressure supply path 14 causes the vacuum pressure stored in the tank 20 to be supplied from the branch point B to the vacuum pressure supply path 12, thereby supplying the vacuum pressure to the holding unit 18. The vacuum pressure supply path 12 and the vacuum pressure supply path 14 are configured by, for example, pipes, but are not limited to the pipes.

The vacuum source 16 is configured by, for example, a vacuum pressure generating device such as a vacuum pump, and generates a vacuum pressure. The vacuum source 16 supplies a vacuum pressure to the holding unit 18 via the vacuum pressure supply path 12. The vacuum source 16 supplies a vacuum pressure to the tank 20 via the vacuum pressure supply path 12 and the vacuum pressure supply path 14.

The holding unit 18 holds an object 26 using the vacuum pressure. The holding force of the holding unit 18 that holds the object 26 is proportional to the pressure difference between the pressure in a space inside the holding unit 18 and the atmospheric pressure. Therefore, in order to reliably hold the object 26 with the holding unit 18, it is preferable that the holding unit 18 is supplied with an air pressure that is sufficiently lower than the atmospheric pressure. In this embodiment, the vacuum pressure means a pressure lower than the atmospheric pressure.

The holding unit 18 is, for example, a vacuum chuck provided in a spindle device 28. The holding unit 18 holds the object 26 by suctioning the object 26 using the vacuum pressure supplied from the vacuum source 16. The holding unit 18 is provided at one end of a spindle shaft (not shown) provided in the spindle device 28. The holding unit 18 rotates along with the rotation of the spindle shaft. The holding unit 18 is formed into, for example, a disk shape, but may be formed into another shape. The holding unit 18 includes a base member 30 and a suction pad 32. The base member 30 is fixed to an end of the spindle shaft. The suction pad 32 is detachably attached to the base member 30. A suction flow path 34 through which air suctioned from the outside flows is formed in the base member 30 and the suction pad 32. A plurality of suction ports 34a communicating with the suction flow path 34 are provided on a suction surface of the suction pad 32. The object 26 is, for example, a workpiece, but is not limited to such a workpiece.

The tank 20 is connected to an end of the vacuum pressure supply path 14. The tank 20 stores the vacuum pressure supplied from the vacuum source 16 via the vacuum pressure supply path 12 and the vacuum pressure supply path 14. The tank 20 supplies the stored vacuum pressure to the holding unit 18 via the vacuum pressure supply path 14 and the vacuum pressure supply path 12.

The sensor 22a is, for example, a pressure sensor. The sensor 22a is disposed on the vacuum pressure supply path 12 and detects the magnitude of the vacuum pressure supplied from the vacuum source 16 to the holding unit 18. Here, the sensor 22a is disposed between the branch point B and the holding unit 18, but may be disposed in another place. For example, the sensor 22a may be located between the vacuum source 16 and the branch point B. Even in this case, when the solenoid valve 24b is closed, the sensor 22a can detect the magnitude of the vacuum pressure supplied from the vacuum source 16 to the holding unit 18.

The sensor 22b is, for example, a pressure sensor. The sensor 22b is installed in the tank 20 and detects the magnitude of the vacuum pressure inside the tank 20.

The solenoid valve 24a is provided on the vacuum pressure supply path 12 between the branch point B and the vacuum source 16, and opens and closes the vacuum pressure supply path 12. The solenoid valve 24a can switch between supplying and not supplying, in supply of the vacuum pressure from the vacuum source 16 to the holding unit 18. The solenoid valve 24a is, for example, a normally-closed solenoid valve, but is not limited to the normally-closed solenoid valve.

The solenoid valve 24b is provided on the vacuum pressure supply path 14, and opens and closes the vacuum pressure supply path 14. The solenoid valve 24b can switch between supplying and not supplying, in supply of the vacuum pressure from the tank 20 to the holding unit 18. The solenoid valve 24b is, for example, a normally-closed solenoid valve, but is not limited to the normally-closed solenoid valve.

When communication between the vacuum pressure supply path 12 and the tank 20 is blocked by closing the solenoid valve 24b, the tank 20 does not affect the supply of the vacuum pressure from the vacuum source 16 to the holding unit 18. As a result, the vacuum pressure can be rapidly supplied from the vacuum source 16 to the holding unit 18. The details will be described later.

The control unit 36 controls the solenoid valve 24a and the solenoid valve 24b. The control unit 36 can be configured by a combination of hardware (processor) and software (program), but is not limited to this combination. The control unit 36 opens and closes the solenoid valve 24a and the solenoid valve 24b by controlling the solenoid valve 24a and the solenoid valve 24b.

Specifically, the control unit 36 performs control for (1) filling the tank 20 with vacuum pressure (filling of the tank 20), (2) holding the object 26 by the holding unit 18 (holding of the object 26), and (3) ending holding of the object 26 with the holding unit 18 (ending of holding of the object 26). The control for filling the tank 20 and the like can be performed based on an instruction from an operator (or a program of the control unit 36). The operator can instruct filling of the tank 20 or the like using the operation unit 40.

### Filling of Tank 20

Hereinafter, a case in which filling of the tank 20 is performed will be described. The control unit 36 performs control to open the solenoid valve 24a and the solenoid valve 24b in a state in which the vacuum source 16 is operated. As a result, the vacuum pressure generated by the vacuum source 16 is supplied to the tank 20. At this time, it is preferable that the suction ports 34a of the holding unit 18 are substantially closed.

Thereafter, the control unit 36 determines whether the tank 20 has been filled with the vacuum pressure. When the control unit 36 determines that the tank 20 has been filled with the vacuum pressure, the control unit 36 controls the solenoid valve 24a and the solenoid valve 24b to be in a closed state. That is, the control unit 36 stops the supply of the vacuum pressure to the tank 20. The control unit 36 determines whether or not the tank 20 has been filled with the vacuum pressure based on the magnitude of the vacuum pressure of the tank 20 detected by the sensor 22b or the elapse of time from the start of filling. For example, when the magnitude of the vacuum pressure detected by the sensor 22b reaches a predetermined range, or when the elapsed time from the start of filling reaches a predetermined time, the control unit 36 determines that the tank 20 has been filled with the vacuum pressure.

### Holding of Object 26

A case where holding of the object 26 is performed will be described. In this case, the control unit 36 performs control to bring the solenoid valve 24b into a closed state and bring the solenoid valve 24a into an open state. As a result, since the vacuum pressure is supplied from the vacuum source 16 to the holding unit 18, the holding unit 18 holds the object 26 by suctioning the object 26.

When the solenoid valve 24b is closed and the magnitude of the vacuum pressure detected by the sensor 22a is out of the normal range, the control unit 36 controls the solenoid valve 24b to be opened. As a result, the vacuum pressure stored in the tank 20 is supplied to the holding unit 18 in addition to the vacuum pressure generated by the vacuum source 16. When the magnitude of the vacuum pressure is out of the normal range due to a failure or the like of the vacuum source 16, there is a possibility that the supply of the vacuum pressure to the holding unit 18 is insufficient. If the supply of the vacuum pressure to the holding unit 18 is insufficient, it is difficult for the holding unit 18 to stably hold the object 26. Therefore, by further supplying the vacuum pressure stored in the tank 20 to the holding unit 18, a sufficient vacuum pressure can be supplied to the holding unit 18. As a result, the holding unit 18 can stably hold the object 26.

Here, when the magnitude of the vacuum pressure detected by the sensor 22a is outside the normal range, the control unit 36 may perform control to bring the solenoid valve 24b into the open state and bring the solenoid valve 24a into the closed state. By closing the solenoid valve 24a, it is possible to reduce the influence of failure or the like of the vacuum source 16. For example, when there is a large vacuum leak from the vacuum source 16, it is preferable to close the solenoid valve 24a in the supply of vacuum pressure to the holding unit 18.

The control unit 36 includes a table 36a indicating the normal range for pressure and the like detected by the sensor 22a. The control unit 36 can refer to the table 36a to determine whether or not the magnitude of the vacuum pressure detected by the sensor 22a is within the normal range.

### End of Holding of Object 26

A case where the holding of the object 26 is ended will be described. In this case, the control unit 36 performs control to bring the solenoid valve 24a and the solenoid valve 24b into the closed state. As a result, the supply of the vacuum pressure to the holding unit 18 is stopped, whereby the holding of the object 26 with the holding unit 18 is ended. At this time, the control unit 36 performs control for preventing the object 26 from falling off the holding unit 18. For example, the control unit 36 performs control such that the object 26 is placed on a pedestal or the like.

The control unit 36 displays various kinds of information on the display screen of the display unit 38. These pieces of information include, for example, information on the operating state of the vacuum source 16, information on the operating state of the solenoid valve 24a, information on the operating state of the solenoid valve 24b, and information on the pressures detected by the sensor 22a and the sensor 22b. In addition, the information may include information on whether or not the magnitude of the vacuum pressure detected by the sensor 22a is within the normal range, and information on whether or not the magnitude of the vacuum pressure detected by the sensor 22b is sufficient to fill the tank 20.

The display unit 38 is configured by a liquid crystal display or the like, for example, but is not limited to the liquid crystal display. The operation unit 40 is configured by, for example, a keyboard, a mouse, etc., but is not limited to the keyboard and the mouse. The operation unit 40 may be constituted by a non-illustrated touch panel provided on the screen of the display unit 38. The operator can perform an operation input to the control unit 36 via the operation unit 40. The operator inputs, for example, an instruction to fill the tank 20, hold the object 26, or end the holding of the object 26.

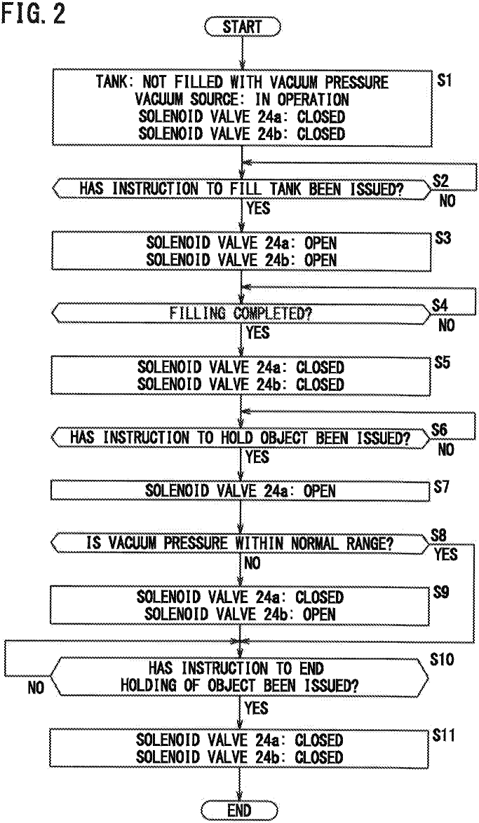

FIG. 2 is a diagram illustrating an example of an operation procedure of the vacuum pressure supply system 10 according to the first embodiment. Here, the vacuum pressure supply system 10 is in an initial state in which the vacuum source 16 is operated, the solenoid valve 24a and the solenoid valve 24b are in a closed state, and the tank 20 is not filled with the vacuum pressure (step S1).

### Filling of Tank 20

In this initial state, the control unit 36 determines whether or not an instruction to fill the tank 20 has been issued (step S2). The instruction to fill the tank 20 may be issued from an operator or from a program.

When the control unit 36 determines that the instruction to fill the tank 20 has been issued (YES in step S2), the control unit 36 performs control to bring the solenoid valve 24a and the solenoid valve 24b into the open state (step S3). As a result, the vacuum pressure generated by the vacuum source 16 is supplied to the tank 20 and then stored in the tank 20. When the instruction to fill the tank 20 is not issued (NO in step S2), the process remains in step S2. Thereafter, the control unit 36 continues this state until the filling of the tank 20 is instructed.

The control unit 36 determines whether or not the tank 20 has been filled with the vacuum pressure (step S4: determination of completion of the filling). This determination can be made based on the magnitude of the vacuum pressure of the tank 20 detected by the sensor 22b or the elapse of time from the start of filling.

When the control unit 36 determines that the tank 20 has been filled with the vacuum pressure (YES in step S4), the control unit 36 performs control to bring the solenoid valve 24a and the solenoid valve 24b into the closed state (step S5). As a result, the supply of the vacuum pressure to the tank 20 is stopped. If it is determined that the filling is not completed (NO in step S4), the process remains in step S4. As a result, the supply of the vacuum pressure to the tank 20 is continued.

### Holding of Object 26

Next, the control unit 36 determines whether or not an instruction to hold the object 26 has been issued (step S6). The instruction to hold the object may be issued from the operator or a program.

When the control unit 36 determines that the instruction to hold the object 26 has been issued (YES in step S6), the control unit 36 performs control to bring the solenoid valve 24a into the open state (step S7). As a result, the vacuum pressure generated by the vacuum source 16 is supplied to the holding unit 18 via the vacuum pressure supply path 12. Accordingly, the holding unit 18 holds the object 26 by sucking the object 26. When the instruction to hold the object 26 is not issued (NO in step S6), the process remains in step S6. Thereafter, the control unit 36 continues this state until the instruction to hold the object 26 is issued.

After the control unit 36 has opened the solenoid valve 24a, the control unit 36 determines whether or not the magnitude of the vacuum pressure detected by the sensor 22a is within the normal range (step S8). When the magnitude of the vacuum pressure is within the normal range (YES in step S8), the vacuum pressure generated by the vacuum source 16 continues to be supplied to the holding unit 18 without change. As a result, the holding unit 18 continues to hold the object 26.

On the other hand, when the magnitude of the vacuum pressure is out of the normal range (NO in step S8), the control unit 36 performs control to close the solenoid valve 24a and open the solenoid valve 24b (step S9). That is, instead of the vacuum pressure generated by the vacuum source 16, the vacuum pressure stored in the tank 20 is supplied to the holding unit 18. As a result, even when the magnitude of the vacuum pressure is out of the normal range due to a failure or the like of the vacuum source 16, a sufficient vacuum pressure is supplied to the holding unit 18. In step S9, the control unit 36 can close the solenoid valve 24a to thereby reduce the influence of a failure or the like of the vacuum source 16. For example, even when a large vacuum leak occurs in the vacuum source 16, by closing the solenoid valve 24a, the vacuum pressure can be supplied from the tank 20 to the holding unit 18 without being affected by the vacuum leak.

In step S9, the control unit 36 may perform control such that the solenoid valve 24a is not brought into the closed state and the solenoid valve 24b is brought into the open state. In this case, the vacuum pressure stored in the tank 20 in addition to the vacuum pressure generated by the vacuum source 16 is supplied to the holding unit 18. It is preferable to supply vacuum pressure from both the vacuum source 16 and the tank 20 unless there is a significant vacuum leak from the vacuum source 16. Thus, the supply amount of the vacuum pressure to the holding unit 18 is increased as compared with the case where the vacuum pressure is supplied from only the tank 20 to the holding unit 18, and the supply of the vacuum pressure is stabilized.

### End of Holding of Object 26

The control unit 36 determines whether or not an instruction to end the holding of the object 26 has been issued (step S10). The instruction to end the holding of the object 26 may be issued from the operator or from a program.

When the control unit 36 determines that the instruction to end the holding of the object 26 has been issued (YES in step S10), the control unit 36 performs control to bring the solenoid valve 24a and the solenoid valve 24b into the closed state (step S11). Accordingly, the supply of the vacuum pressure to the holding unit 18 is stopped. As a result, the holding unit 18 no longer holds the object 26. When the instruction to end the holding of the object is not issued (NO in step S10), the process remains in step S10. Thereafter, the holding of the object 26 is continued until the end of the holding of the object is instructed.

In the first embodiment, the vacuum pressure supply path 14 branches off from the vacuum pressure supply path 12 that supplies vacuum pressure from the vacuum source 16 to the holding unit 18. The vacuum pressure supply path 14 is connected to the tank 20, and the solenoid valve 24b is disposed in the vacuum pressure supply path 14. Therefore, when communication between the vacuum pressure supply path 12 and the tank 20 is blocked by closing the solenoid valve 24b, the tank 20 does not affect the supply of the vacuum pressure from the vacuum source 16 to the holding unit 18. As a result, the vacuum pressure can be rapidly supplied from the vacuum source 16 to the holding unit 18. For example, when the vacuum source 16, the tank 20, and the holding unit 18 are arranged in this order on the vacuum pressure supply path 12, it takes time to supply the vacuum pressure from the vacuum source 16 to the holding unit 18. That is, when the tank 20 is disposed between the vacuum source 16 and the holding unit 18, supply of the vacuum pressure to the holding unit 18 is started after the tank 20 has been filled with the vacuum pressure. As a result, it takes time to supply the vacuum pressure from the vacuum source 16 to the holding unit 18. On the other hand, in the present embodiment, by blocking the communication between the vacuum pressure supply path 12 and the tank 20, the vacuum pressure can be quickly supplied from the vacuum source 16 to the holding unit 18. Owing to this, the object 26 can be quickly held.

In addition, in the first embodiment, when the vacuum pressure is supplied from the vacuum source 16 to the holding unit 18, if the magnitude of the vacuum pressure on the vacuum pressure supply path 12 is out of the normal range, the control unit 36 performs control to bring the solenoid valve 24b into the open state. As a result, the vacuum pressure stored in the tank 20 is supplied to the holding unit 18. Accordingly, even when it is difficult to supply a sufficient vacuum pressure from the vacuum source 16 to the holding unit 18 due to a failure or the like of the vacuum source 16, a sufficient vacuum pressure can be supplied to the holding unit 18. That is, it becomes easy to stably hold the object 26. Note that when the magnitude of the vacuum pressure on the vacuum pressure supply path 12 is outside the normal range, the control unit 36 may perform control to open the solenoid valve 24b and close the solenoid valve 24a.

### Second Embodiment

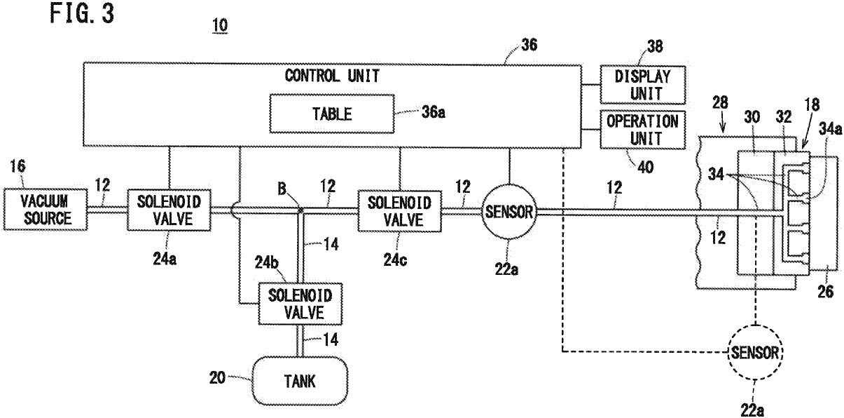

A vacuum pressure supply system according to a second embodiment will be described. FIG. 3 is a diagram illustrating the vacuum pressure supply system according to the present embodiment. As shown in FIG. 3, in the vacuum pressure supply system 10 according to the present embodiment, a solenoid valve 24c is added to the first embodiment. Also, the sensor 22b is excluded.

The solenoid valve 24c is provided on the vacuum pressure supply path 12 between the branch point B and the holding unit 18, and opens and closes the vacuum pressure supply path 12. In the present embodiment, by closing the solenoid valve 24c and opening the solenoid valve 24a and the solenoid valve 24b, the vacuum pressure can be supplied from the vacuum source 16 to the tank 20 without the vacuum pressure being consumed by the holding unit 18. This makes it easier to determine the filling of the tank 20 based on the elapse of time from the start of the filling. Since the filling of the tank 20 is determined based on the elapse of time, the sensor 22b is excluded in the present embodiment. However, the vacuum pressure supply system 10 may include a sensor 22b and determine whether or not the tank 20 has been filled, by using the sensor 22b.

The sensor 22a is provided between the solenoid valve 24c and the holding unit 18. That is, the sensor 22a is disposed closer to the holding unit 18 than the branch point B and the solenoid valve 24c are. Accordingly, the state of the holding unit 18 can be more accurately grasped by the sensor 22a. As indicated by an imaginary line in FIG. 3, the sensor 22a may be installed not on the vacuum pressure supply path 12 but on the holding unit 18. In this case, the sensor 22a directly detects the vacuum pressure of the holding unit 18.

The control unit 36 performs control for (1) filling the tank 20, (2) holding the object 26, and (3) ending the holding of the object 26, by using the solenoid valve 24a, the solenoid valve 24b, and the solenoid valve 24c.

### Filling of Tank 20

For filling the tank 20, the control unit 36 performs control to open the solenoid valve 24a and the solenoid valve 24b and close the solenoid valve 24c, in a state where the vacuum source 16 is operated. As a result, the vacuum pressure generated by the vacuum source 16 is supplied to the tank 20. At this time, in the present embodiment, unlike the first embodiment, the supply of the vacuum pressure to the holding unit 18 is stopped by closing the solenoid valve 24c. For this reason, in the present embodiment, the state of the holding unit 18 does not matter in the filling of the tank 20.

Thereafter, the control unit 36 determines whether the tank 20 has been filled with the vacuum pressure. When the control unit 36 determines that the tank 20 has been filled with the vacuum pressure, the control unit 36 controls the solenoid valve 24a and the solenoid valve 24b to be in the closed state. As a result, the supply of the vacuum pressure to the tank 20 is stopped. As described above, the supply of the vacuum pressure to the holding unit 18 is already stopped. Therefore, it becomes easier to determine the filling of the tank 20 based on the elapse of time from the start of the filling.

### Holding of Object 26

For holding the object 26, the control unit 36 performs control to close the solenoid valve 24b and open the solenoid valve 24a and the solenoid valve 24c. As a result, the vacuum pressure generated by the vacuum source 16 is supplied to the holding unit 18.

Here, when the magnitude of the vacuum pressure detected by the sensor 22a is outside the normal range, the control unit 36 performs control to bring the solenoid valve 24b into the open state. As a result, a sufficient vacuum pressure is supplied to the holding unit 18. Accordingly, the holding unit 18 can stably hold the object 26. Note that when the magnitude of the vacuum pressure detected by the sensor 22a is outside the normal range, the control unit 36 may perform control to bring the solenoid valve 24b into the open state and bring the solenoid valve 24a into the closed state.

### End of Holding of Object 26

For ending the holding of the object 26, the control unit 36 performs control to bring the solenoid valve 24a, the solenoid valve 24b, and the solenoid valve 24c into the closed state, for example. As a result, the supply of the vacuum pressure to the holding unit 18 is stopped, and the holding of the object 26 with the holding unit 18 is ended.

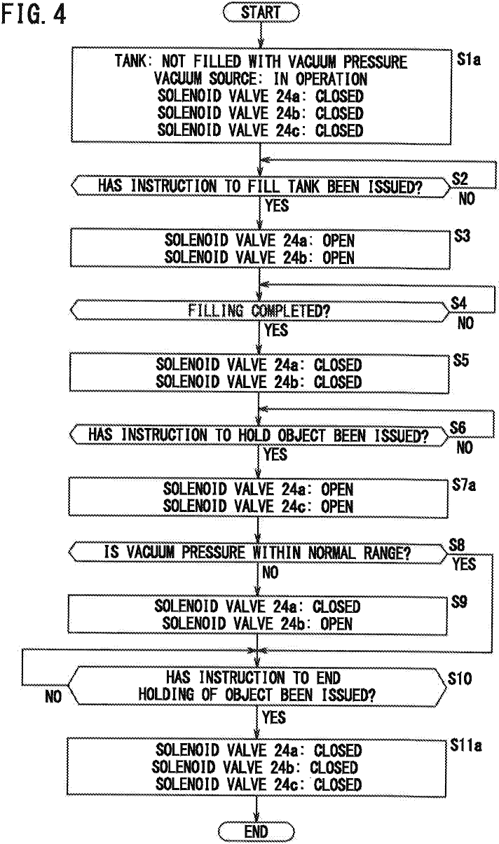

FIG. 4 is a diagram illustrating an example of an operation procedure of the vacuum pressure supply system 10 according to the second embodiment. Here, the vacuum pressure supply system 10 is in an initial state in which the vacuum source 16 is operated, the solenoid valve 24a, the solenoid valve 24b, and the solenoid valve 24c are in the closed state, and the tank 20 is not filled with the vacuum pressure (step S1a).

Thereafter, the filling of the tank 20 is started. First, when the control unit 36 determines that the instruction to fill the tank 20 has been issued (YES in step S2), the control unit 36 performs control to bring the solenoid valve 24a and the solenoid valve 24b into the open state (step S3). As a result, the vacuum pressure generated by the vacuum source 16 is supplied to the tank 20 and then stored in the tank 20. Thereafter, when the control unit 36 determines that the tank 20 has been filled with the vacuum pressure (YES in step S4), the control unit 36 performs control to bring the solenoid valve 24a and the solenoid valve 24b into the closed state (step S5). As a result, the supply of the vacuum pressure to the tank 20 is stopped. In steps S2 to S5, the solenoid valve 24c continues to be in the closed state of step S1a. Therefore, in steps S3 and S4, the vacuum pressure generated by the vacuum source 16 is supplied to the tank 20 without being consumed by the holding unit 18. As a result, in step S3, the vacuum pressure generated by the vacuum source 16 can be efficiently supplied to the tank 20. In addition, in step S4, it becomes easy to determine the completion of the filling based on the elapse of time from the start of the filling.

After filling of the tank 20, holding of the object 26 is performed. First, when the control unit 36 determines that the instruction to hold the object 26 has been issued (YES in step S6), the control unit 36 performs control to bring the solenoid valve 24a and the solenoid valve 24c into the open state (step S7a). As a result, the vacuum pressure generated by the vacuum source 16 is supplied to the holding unit 18. Accordingly, the holding unit 18 holds the object 26. Thereafter, when the magnitude of the vacuum pressure detected by the sensor 22a is out of the normal range (NO in step S8), the control unit 36 performs control to bring the solenoid valve 24a into the closed state and bring the solenoid valve 24b into the open state (step S9). As a result, the vacuum pressure stored in the tank 20 is supplied to the holding unit 18 in place of the vacuum pressure generated by the vacuum source 16. Accordingly, even when the vacuum source 16 fails or the like, a sufficient vacuum pressure is supplied to the holding unit 18. When the control unit 36 determines that the instruction to end the holding of the object 26 has been issued (YES in step S10), the control unit 36 performs control to bring the solenoid valve 24a, the solenoid valve 24b, and the solenoid valve 24c into the closed state (step S11a). Accordingly, the supply of the vacuum pressure to the holding unit 18 is stopped. As a result, the holding unit 18 no longer holds the object 26.

In the present embodiment, the solenoid valve 24a can be omitted as in the first embodiment. That is, even if the solenoid valve 24a is not provided, substantially the same processing as that in the case where the solenoid valve 24a is provided can be performed by the solenoid valve 24b and the solenoid valve 24c. To be more specific, in the operation procedure shown in FIG. 4, the operation of the solenoid valve 24a is ignored and the solenoid valves 24b and 24c only have to be opened and closed.

Since the second embodiment is the same as the first embodiment except for the above points, detailed description thereof will be omitted.

### Modified Examples

Although preferred embodiments of the present invention have been described above, the present invention is not limited to the above-described embodiments, and various modifications can be made thereto within a range that does not depart from the essence and gist of the present invention.

In the above-described embodiment, the case where the holding unit 18 is provided in the spindle device 28 has been described as an example, but the present invention is not limited thereto. The holding unit 18 may be provided in a robot hand or the like.

### Invention Obtained From the Embodiments

The invention graspable from the embodiments described above will be recited below.

[1] The vacuum pressure supply system (10) includes: a first vacuum pressure supply path (the vacuum pressure supply path 12) configured to allow a vacuum pressure to be supplied from the vacuum source (16) to the holding unit (18) configured to hold an object (26) using the vacuum pressure; the tank (20) configured to store the vacuum pressure; a second vacuum pressure supply path (the vacuum pressure supply path 14) branching off from the first vacuum pressure supply path and being connected to the tank; and a first solenoid valve (the solenoid valve 24b) provided on the second vacuum pressure supply path. With this configuration, when the vacuum pressure is supplied from the vacuum source to the holding unit, the supply of the vacuum pressure to the holding unit can be facilitated by opening the first solenoid valve and thereby supplying the vacuum pressure from the tank to the holding unit.

[2] The vacuum pressure supply system may further include: a second solenoid valve (the solenoid valve 24c) provided on the first vacuum pressure supply path between the holding unit and the branch point (B) of the second vacuum pressure supply path; and a filling control unit (the control unit 36) configured to perform control to close the second solenoid valve and open the first solenoid valve when filling of the tank with the vacuum pressure is performed while the second solenoid valve is opened. Thus, the vacuum pressure can be supplied from the vacuum source and stored in the tank.

[3] The vacuum pressure supply system may further include: the pressure sensor (the sensor 22a) provided on the first vacuum pressure supply path and configured to detect the magnitude of the vacuum pressure; and a preliminary vacuum pressure control unit (the control unit 36) configured to perform control to open the first solenoid valve when the magnitude of the vacuum pressure detected by the pressure sensor is out of the normal range while the first solenoid valve is closed. Thus, when the magnitude of the vacuum pressure on the first vacuum pressure supply path is out of the normal range, the vacuum pressure can be additionally supplied from the tank to the holding unit.

[4] The pressure sensor may be provided on the first vacuum pressure supply path between the holding unit and the branch point of the second vacuum pressure supply path. With this configuration, the pressure sensor can detect the vacuum pressure of the holding unit with higher accuracy. As a result, the vacuum pressure can be more appropriately supplied from the tank to the holding unit.

[5] The pressure sensor may be provided closer to the holding unit than a second solenoid valve (the solenoid valve 24c) provided on the first vacuum pressure supply path between the holding unit and the branch point of the second vacuum pressure supply path. With this configuration, the pressure sensor can detect the vacuum pressure of the holding unit with higher accuracy. As a result, the vacuum pressure can be more appropriately supplied from the tank to the holding unit.

[6] The vacuum pressure supply system may further include: the pressure sensor (the sensor 22a) provided in the holding unit and configured to detect the magnitude of the vacuum pressure; and a preliminary vacuum pressure control unit (the control unit 36) configured to perform control to open the first solenoid valve when the magnitude of the vacuum pressure detected by the pressure sensor is out of the normal range while the first solenoid valve is closed. Thus, when the magnitude of the vacuum pressure on the first vacuum pressure supply path is out of the normal range, the vacuum pressure can be additionally supplied from the tank to the holding unit.

[7] The vacuum pressure supply system may further include: a third solenoid valve (the solenoid valve 24a) provided on the first vacuum pressure supply path between the vacuum source and the branch point of the second vacuum pressure supply path; and a supply control unit (the control unit 36) configured to perform control to open the third solenoid valve when supply of the vacuum pressure to the holding unit or the tank is performed while the third solenoid valve is closed. With this configuration, by opening and closing the third solenoid valve, it is possible to switch between supply and non-supply in the supply of the vacuum pressure to the holding unit or the tank.

[8] The vacuum pressure supply system may further include: a third solenoid valve (the solenoid valve 24a) provided on the first vacuum pressure supply path between the vacuum source and the branch point of the second vacuum pressure supply path, and the preliminary vacuum pressure control unit may perform control to open the first solenoid valve and close the third solenoid valve when the magnitude of the vacuum pressure detected by the pressure sensor is out of the normal range while the first solenoid valve is closed and the third solenoid valve is opened. With this configuration, when the magnitude of the vacuum pressure on the first vacuum pressure supply path is out of the normal range, the vacuum pressure of the tank can be supplied to the holding unit instead of the vacuum pressure of the vacuum source.

1. A vacuum pressure supply system comprising:
a first vacuum pressure supply path configured to allow a vacuum pressure to be supplied from a vacuum source to a holding unit configured to hold an object using the vacuum pressure;
a tank configured to store the vacuum pressure;
a second vacuum pressure supply path branching off from the first vacuum pressure supply path and being connected to the tank; and
a first solenoid valve provided on the second vacuum pressure supply path.

2. The vacuum pressure supply system according to claim 1, further comprising:
a second solenoid valve provided on the first vacuum pressure supply path between the holding unit and a branch point of the second vacuum pressure supply path; and
a filling control unit configured to perform control to close the second solenoid valve and open the first solenoid valve when filling of the tank with the vacuum pressure is performed while the second solenoid valve is opened.

3. The vacuum pressure supply system according to claim 1 further comprising:
a pressure sensor provided on the first vacuum pressure supply path and configured to detect a magnitude of the vacuum pressure; and
a preliminary vacuum pressure control unit configured to perform control to open the first solenoid valve when the magnitude of the vacuum pressure detected by the pressure sensor is out of a normal range while the first solenoid valve is closed.

4. The vacuum pressure supply system according to claim 3, wherein
the pressure sensor is provided on the first vacuum pressure supply path between the holding unit and a branch point of the second vacuum pressure supply path.

5. The vacuum pressure supply system according to claim 4, wherein
the pressure sensor is provided closer to the holding unit than a second solenoid valve provided on the first vacuum pressure supply path between the holding unit and the branch point of the second vacuum pressure supply path.

6. The vacuum pressure supply system according to claim 1 further comprising:
a pressure sensor provided in the holding unit and configured to detect a magnitude of the vacuum pressure; and
a preliminary vacuum pressure control unit configured to perform control to open the first solenoid valve when the magnitude of the vacuum pressure detected by the pressure sensor is out of a normal range while the first solenoid valve is closed.

7. The vacuum pressure supply system according to claim 1 further comprising:
a third solenoid valve provided on the first vacuum pressure supply path between the vacuum source and a branch point of the second vacuum pressure supply path; and
a supply control unit configured to perform control to open the third solenoid valve when supply of the vacuum pressure to the holding unit or the tank is performed while the third solenoid valve is closed.

8. The vacuum pressure supply system according claim 3, further comprising:
a third solenoid valve provided on the first vacuum pressure supply path between the vacuum source and a branch point of the second vacuum pressure supply path,
wherein the preliminary vacuum pressure control unit performs control to open the first solenoid valve and close the third solenoid valve when the magnitude of the vacuum pressure detected by the pressure sensor is out of the normal range while the first solenoid valve is closed and the third solenoid valve is opened.
